(19) United States
(12) Patent Application Publication
(10) Pub. No.: US 2019/0258995 A1
(43) Pub. Date: Aug. 22, 2019

(54) SYSTEMS AND METHODS FOR INTELLIGENT HYBRID SHIPPING INTAKE

(71) Applicant: David Crane, Montrose, CO (US)

(72) Inventor: David Crane, Montrose, CO (US)

(21) Appl. No.: 16/386,056

(22) Filed: Apr. 16, 2019

Related U.S. Application Data
(63) Continuation-in-part of application No. 15/172,696, filed on Jun. 3, 2016.
(60) Provisional application No. 62/170,609, filed on Jun. 3, 2015.
(60) Provisional application No. 62/222,496, filed on Sep. 23, 2015.

(51) Int. Cl. G06Q 10/08; G01B 21/02; G01G 19/62

(52) U.S. Cl. CPC G06Q 10/0838; G01G 19/62; G01B 21/02

(57) ABSTRACT

A system for shipping management. The system includes a shipping database configured to receive shipping information from a user regarding a physical package and an access point. The access point is connected to the shipping database and configured to receive the shipping information from the shipping database. The access point is also configured to measure at least one attribute of the physical package and configured to send the measured attribute to the shipping database to be added to the shipping information. The system also includes a package drop. The package drop configured to receive the shipping information from the database and accept the physical package from the user. The package drop is also configured to store the physical package until pickup by a shipping provider and based on the shipping provider assigning the physical package to a collection box.

### CROSS-REFERENCE TO RELATED APPLICATIONS

This application is a continuation-in-part of, and claims the benefit of and priority to, U.S. Non-Provisional patent application Ser. No. 15/172,696 filed on Jun. 3, 2016, which application is incorporated herein by reference in its entirety

U.S. Non-Provisional patent application Ser. No. 15/172,696 claims the benefit of and priority to U.S. Provisional Patent Application Ser. No. 62/170,609 filed on Jun. 3, 2015, which application is incorporated herein by reference in its entirety

U.S. Non-Provisional patent application Ser. No. 15/172,696 claims the benefit of and priority to U.S. Provisional Patent Application Ser. No. 62/222,496 filed on Sep. 23, 2015, which application is incorporated herein by reference in its entirety.

### BACKGROUND OF THE INVENTION

Package shipping intake or enrollment at retail locations is typically a linear process with ship to address look up and input/application, ship from address look up and input/application and payment happening one at a time. While effective, it is a slow system and frequently results in error due to omission, transcription, sloppiness in as handwriting and so forth.

Accordingly a faster system to apply the ship to and from addresses is needed and, in some iterations, integration with payment information and processing can reduce errors and increase efficiency for the customer shipping the package and the carrier alike.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for shipping management. The system includes a shipping database configured to receive shipping information from a user regarding a package. The system also includes an access point, the access point connected to the shipping database and configured to receive the shipping information from the shipping database. The access point is also configured to measure at least one attribute of the package and send the measured attribute to the shipping database to be added to the shipping information. The system also includes a package drop, the package drop configured to receive the shipping information from the database, accept a package from the user and store the package until pickup by a shipping provider.

One example embodiment includes a system for shipping management. The system includes a shipping database configured to receive shipping information from a user regarding a physical package and an access point. The access point is connected to the shipping database and configured to receive the shipping information from the shipping database. The access point is also configured to measure at least one attribute of the physical package and configured to send the measured attribute to the shipping database to be added to the shipping information. The system also includes a package drop. The package drop configured to receive the shipping information from the database and accept the physical package from the user. The package drop is also configured to store the physical package until pickup by a shipping provider and based on the shipping provider assigning the physical package to a collection box.

Another example embodiment includes a system for shipping management. The system includes a shipping database configured to receive shipping information from a user regarding a physical package and an access point. The access point is connected to the shipping database and configured to receive the shipping information from the shipping database. The access point is also configured to measure at least one attribute of the physical package and configured to send the measured attribute to the shipping database to be added to the shipping information. The access point is further configured to determine if the dimensions of the physical package are below a predetermined size threshold and determine if the weight of the physical package is below a predetermined weight threshold when the dimensions of the physical package are below the predetermined size threshold. The access point is additionally configured to assign the physical package to a common bin assigned to the shipping provider when the physical package is below the predetermined size threshold and below the predetermined weight threshold and assigning the physical package to a collection bin then assign the collection bin to the shipping provider when the physical package is above either the predetermined size threshold or the predetermined weight threshold. The system also includes a package drop. The package drop configured to receive the shipping information from the database and accept the physical package from the user. The package drop is also configured to store the physical package in either the shipping provider's common bin or the collection box.

Another example embodiment includes a system for shipping management. The system includes a shipping database configured to receive shipping information from a user regarding a physical package and an access point. The access point is connected to the shipping database and configured to receive the shipping information from the shipping database. The access point is also configured to measure at least one attribute of the physical package and configured to send the measured attribute to the shipping database to be added to the shipping information. The access point is further configured to determine if the dimensions of the physical package are below a predetermined size threshold and determine if the weight of the physical package is below a predetermined weight threshold when the dimensions of the physical package are below the predetermined size threshold. The access point is additionally configured to assign the physical package to a common bin assigned to the shipping provider when the physical package is below the predetermined size threshold and below the predetermined weight threshold and assigning the physical package to a collection bin then assign the collection bin to the shipping provider when the physical package is above either the predetermined size threshold or the predetermined weight threshold. The system also includes a package drop. The package drop configured to receive the shipping information from the database and accept the physical package from the user. The package drop is also configured to store the physical package in either the shipping provider's common bin or the collection box and opening the shipping provider's common bin and all collection boxes assigned to the shipping provider to release the physical packages therein to the shipping provider.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 is a block diagram illustrating an example of a system for retail shipping management;

FIG. 2 illustrates an example of an access point;

FIG. 3 illustrates an example of a user interface;

FIG. 4 illustrates an example of a package drop;

FIG. 5 is a flow chart illustrating an example of a hybrid intelligent intake method;

FIG. 6 is a flowchart illustrating an example of a method for one particular hybrid intelligent intake system;

FIG. 7 is a flowchart illustrating a method of providing packages at a drop box to a shipping provider; and

FIG. 8 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

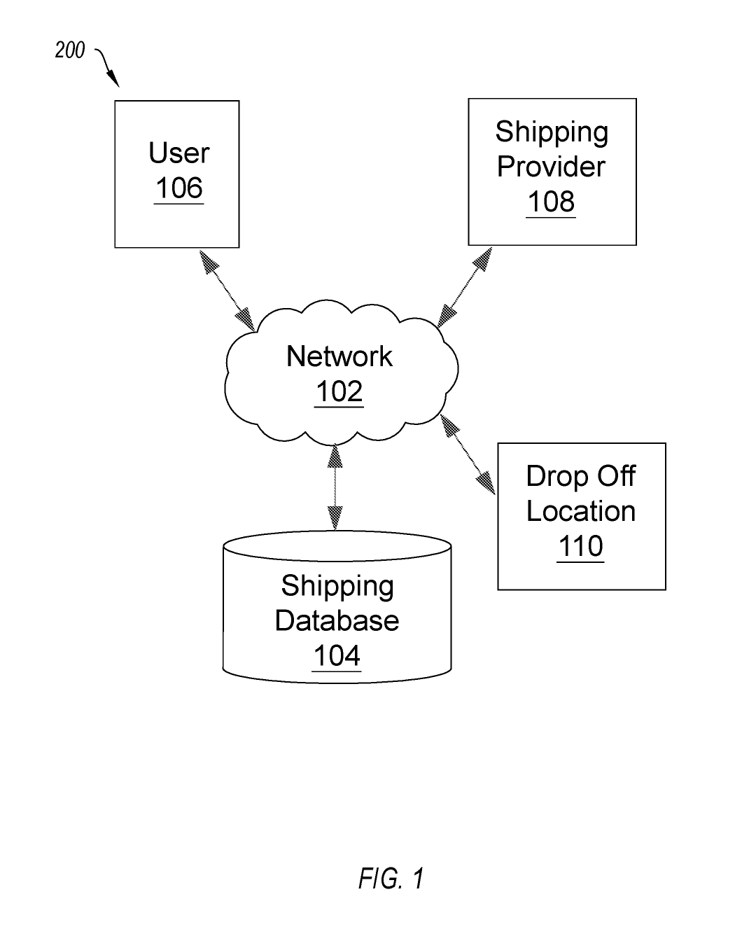

FIG. 1 is a block diagram illustrating an example of a system 100 for retail shipping management. In at least one implementation, the system 100 can be used to allow shipping customers speed up, facilitate and increase the accuracy of enrolling a package into a shipping system. The system 100 additionally increases usability and speed for a consumer. In particular, the system 100, as shown below, gives consumers relevant information quickly and passes information to where it is most needed by consumers to decrease time spent by the consumer in sending a package.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include shipping database 104. In at least one implementation, the shipping database 104 can include any system capable of storing and retrieving the desired data files. For example, the shipping database 104 can include an electronic database capable of electronically storing data. E.g., the shipping database 104 can include memory or memory banks. Additionally or alternatively, the shipping database 104 can include processors or other logic devices capable of executing software or carrying out other computer algorithms. The shipping database 104 can allow a user to access the hardware of the shipping database 104 for remote computing or for information retrieval.

FIG. 1 further shows that the system 100 can include a user 106. In at least one implementation, the user 106 can include any individual, business, organization or other entity which uses the system 100. For example, the user 106 can include a retail entity that ships products to consumers. Additionally or alternatively, the user 106 can include a company that ships to retail locations for sale to a consumer. The user 106 can access his/her user information in the shipping database 104 over the network 102. The user accesses the system 100 through one or more access points and/or user interfaces, as described below.

FIG. 1 additionally shows that the system 100 can include a shipping provider 108. The shipping provider 108 include any organization that provides a shipping service, such as UPS, FedEx, USPS, freight services or any other shipping company. In particular, the shipping provider 108 can receive a package at a designated location from a user 106 then deliver the package to a location specified by the user 106.

FIG. 1 moreover shows that the system 100 can include a drop off location 110. The drop off location 110 allows a user to deposit the package for actual shipment. I.e., the drop off location 110 is the site where the package transitions from user control to the custody of the shipping provider 110. For example, the drop off location 110 can include an access point or a package drop, as described below, or can be any other location where the shipping provider will receive the package (such as pickup at the user's location).

In at least one implementation, the user 106 records information about the package in the shipping database 104 over the network 102. The information can then be retrieved as needed by either the user 106 or the shipping provider 108 from the shipping database 104 over the network 102. The information can include any desired information; for example, the information can include time information, such as when the package was left with the shipping provider 108 or when the package is to be delivered, can include care information, such as what services were requested by the user 106 and/or performed by the shipping provider 108 or can include any other desired information. Additionally or alternatively, the information can include requests made by the user 106 such as, cost information, payment information (including but not limited to Credit Card, PayPal, Google Checkout, Close-Loop Valet Parking Account and Bill to Mobile Phone Carrier) or any other desired user request.

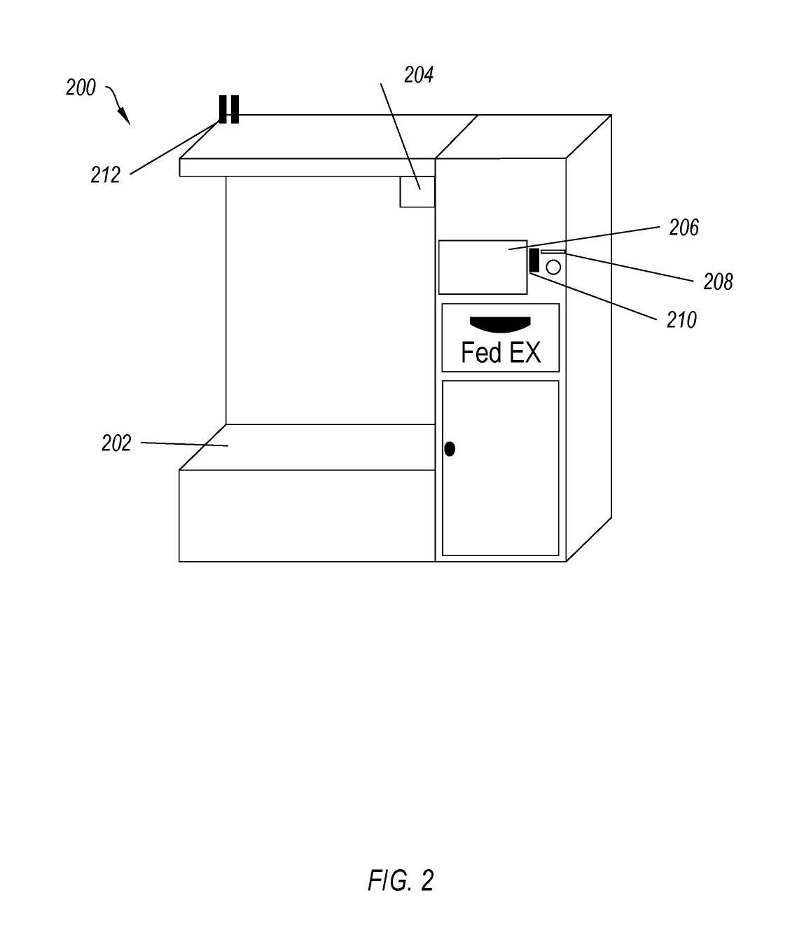

FIG. 2 illustrates an example of an access point 200. The exemplary access point 200 is a kiosk but other access points can include storefronts, mobile shipping units (such as trucks to pick up a package) or any other location where packages can be received for shipment. The access point 200 can allow a user to input desired shipping information, obtain costs and turn the package over to the shipping provider or can receive previously input information regarding the package and accept the package to be given to the shipping provider.

FIG. 2 shows that the access point 200 includes a scale 202. The scale 202 allows the weight of the package to be determined. For example, the scale 202 can include an input that allows a user to enter the weight or can include a device that measures and records the weight of the package. For example, the scale 202 can be configured to measure the weight of the package with an accuracy of approximately 0.01 pounds. As used in the specification and the claims, the phrase “configured to” denotes an actual state of configuration that fundamentally ties recited elements to the physical characteristics of the recited structure. That is, the phrase “configured to” denotes that the element is structurally capable of performing the cited element but need not necessarily be doing so at any given time. As a result, the phrase “configured to” reaches well beyond merely describing functional language or intended use since the phrase actively recites an actual state of configuration. As used in the specification and the claims, the term approximately shall mean that the value is within 10% of the stated value, unless otherwise specified.

FIG. 2 also shows that the access point 200 can include a size sensor 204. The size sensor 204 allows the size or dimensions of the package to be determined. For example, the size sensor 204 can include an input that allows a user to enter the dimensions or can include a device that measures and records the size of the package. For example, the size sensor 204 can be configured to measure the dimensions of the package with an accuracy of approximately 0.1 inches.

FIG. 2 further shows that the access point 200 can include a user interface 206. The user interface 206 allows a user to enter desired information about the package such as contacts, account information, id information, ship to data, ship from data, payment methods, payment preferences, receipts, history, tracking data, coupons, special offers, social networking, sharing of information/offers or any other desired information. The user interface 206 can be touchscreen or can include a keyboard or other input device that allows a user to access or enter desired information.

FIG. 2 additionally shows that the access point 200 can include a label printer 208. The label printer 208 creates a label that includes information required by the carrier such as the destination address, tracking number and origination address. Additionally or alternatively, the label can include a code that can be scanned to obtain information electronically, such as a bar code or QR code. The label printer 208 can print a label that is placed on the package by a user or other individual or can print the label directly on the package, as desired.

FIG. 2 moreover shows that the access point 200 can include a payment input 210. The payment input 210 allows a user to pay for the package shipping. For example, the payment input 210 can include a credit card reader or NFC payment system. One of skill in the art will appreciate that the payment input 210 can be associated with or combined with the user interface 206. For example, the user interface 206 can allow a user to log in to his/her account and apply previously stored payment information or allow a user to pay via electronic payment systems such as PayPal.

FIG. 2 also shows that the access point 200 can include a communication module 212. The communication module 212 can allow a user to input information though an electronic handoff from a device such as a smartphone or via the internet. Additionally or alternatively, the communication module 212 can allow a shipping provider to retrieve shipping information from the access point for packages left at the access point. For example, the communication module 212 can send the shipping information via secure electronic communication or via electronic communication to an electronic device in proximity to the access point (e.g., integrated into a shipping truck).

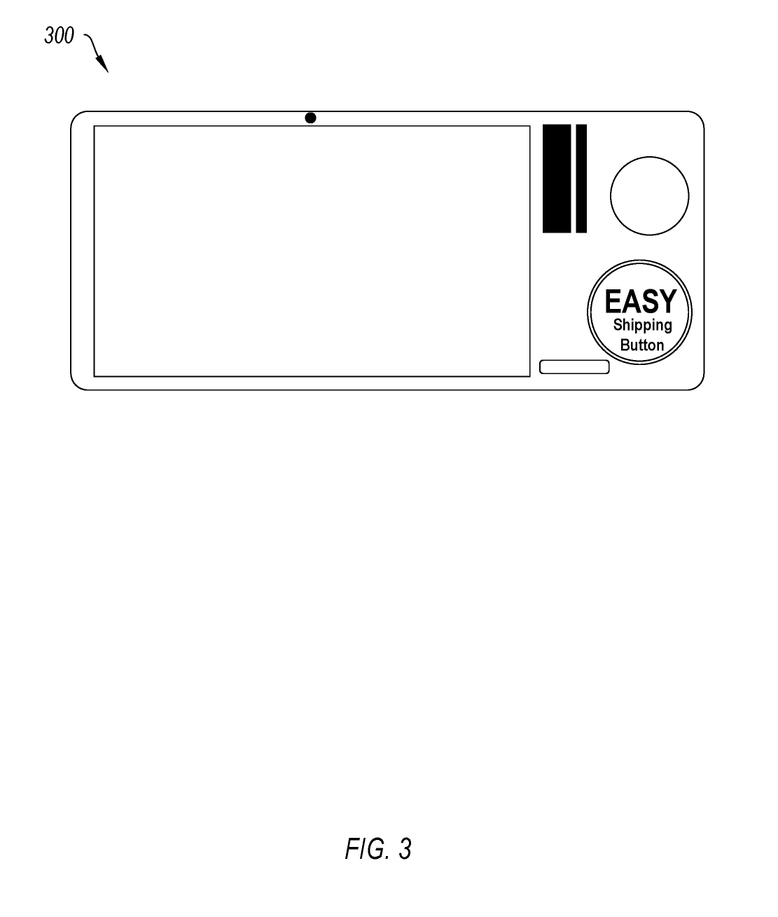

FIG. 3 illustrates an example of a user interface 300. The user interface is provided to the user at an access point, such as a webpage, at a kiosk, via a smart phone app or via any other desired medium. The user interface 300 can allow the user to enter or retrieve information necessary for the shipping of the package. For example, the user interface can allow a user to access his/her account to retrieve shipping information and/or payment information. The user interface 300 can include a graphical user interface, controls, speakers, displays or any other necessary hardware and/or software to adequately display the desired information to the user, as described below.

In at least one implementation, a graphical user interface (“GUI” sometimes pronounced gooey) is a type of user interface 300 that allows users to interact with electronic devices with images rather than text commands. GUIs can be used in computers, hand-held devices such as MP3 players, portable media players or gaming devices, cell phones, household appliances and office equipment. A GUI represents the information and actions available to a user through graphical icons and visual indicators such as secondary notation, as opposed to text-based interfaces, typed command labels or text navigation. The actions are usually performed through direct manipulation of the graphical elements.

By way of example, the user interface 300 can include a computer program, app, webpage, website, or some other means for conveying desired information to a user. For example, the user interface 300 can include a website that a user can log on to and view contacts, previous shipments, address where the package should be picked up, pick up date, delivery date, payment information, etc. For example, the user interface 300 can include an app for a smart phone that allows the user to retrieve and/or enter shipping information via a mobile device such as a cell phone, smart phone, tablet, laptop/computer or any other electronic device.

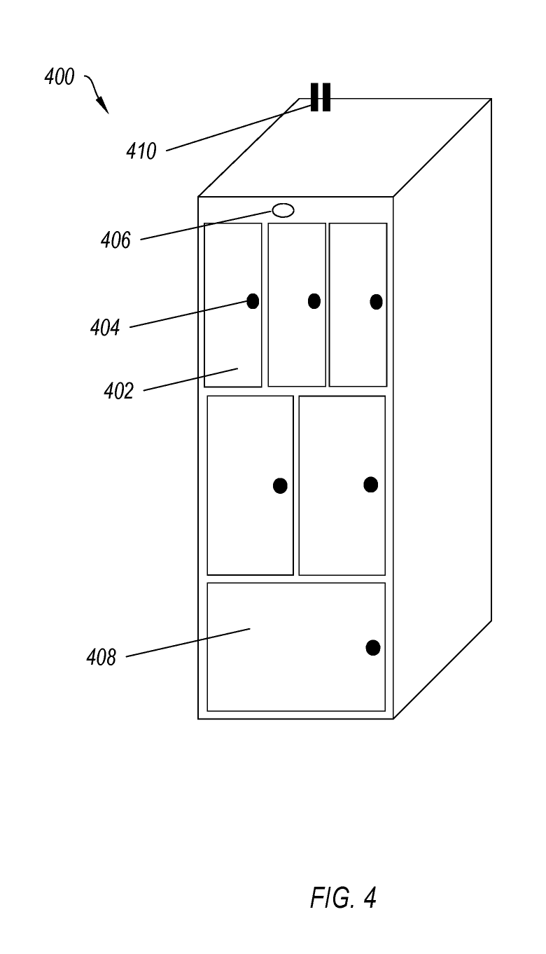

FIG. 4 illustrates an example of a package drop 400. The package drop 400 provides a secure location for the package after it is left by the recipient. The package drop 400 can be integrated with the user interface 300 of FIG. 3 and/or the access point 200 of FIG. 2 or can be a standalone device. For example, a business with high shipping volume may have a kiosk installed but may not need a secure package drop 400 as the shipping carrier comes to the business to retrieve packages. One of skill in the art will appreciate that the user can enter all relevant information via the user interface 300 of FIG. 3, send the information to an access point 200 of FIG. 2 received via communication module 212 of FIG. 2, weigh and measure the package at the access point 200 of FIG. 2, receive a label from the label printer 208 and leave the package at the package drop 400.

FIG. 4 shows that the package drop 400 can include a collection box 402. The collection box 402 is configured to receive a package that meets size and weight requirements. That is, any package that is below the maximum size and weight of the collection box 402 can be left in the collection box 402. The package drop 400 can include standard sizes or oversized boxes as desired. One of skill in the art will appreciate that the package drop 400 can include multiple collection boxes 402 if so desired. For example, the package drop 400 can include a first collection box 402 for standard size packages, a second collection box 402 for oversized packages, a third collection box 402 for envelopes and a fourth collection box 402 for long packages.

FIG. 4 further shows that the package drop 400 can include an electronic lock 404. The electronic lock 404 secures the collection box 402 when not in use and allows the collection box 402 to be opened when a package is expected. That is, the electronic lock can receive a signal that a package is ready to be deposited and allow the collection box 402 to be accessed by the user.

FIG. 4 additionally shows that the package drop 400 can include an indicator 406. The indicator 406 alerts a user that the electronic lock 404 has disengaged and the collection box 402 can be opened to allow deposit of the package. For example, the indicator 406 can include an audio sound and/or a visual indicator. E.g., if the package drop 400 includes multiple collection boxes 402 the indicator 406 can include a visual indicator of in which collection box 402 the package should be deposited.

FIG. 4 also shows that the package drop 400 can include a secure storage 408. The secure storage 408 receives the package from the collection box 402 and is secured against unauthorized retrieval. For example, the secure storage 408 can be below the collection box 402 so that when the door to the collection box 402 is closed the package is gravity fed to the secure storage 408. The collection box can include a standard lock that allows the shipping provider to retrieve packages from the secure storage 408.

FIG. 4 moreover shows that the package drop 400 can include a communication module 410. The communication module 410 can receive signals from an access point that a package is to be dropped off at the package drop 400. Likewise, a signal can be sent via wireless communication, such as Bluetooth or NFC, that deposit is initiated (i.e., that all portions of the transaction including production of a shipping label have been completed) and that the package drop 400 should be authorized. In addition, the communication module 410 can send an indication that pickup by the carrier should be scheduled, either because packages are present or that pickup should be expedited if the space in the secure storage 408 is at or near capacity. Additionally or alternatively, the communication module 410 can indicate that service is needed because an error has been encountered.

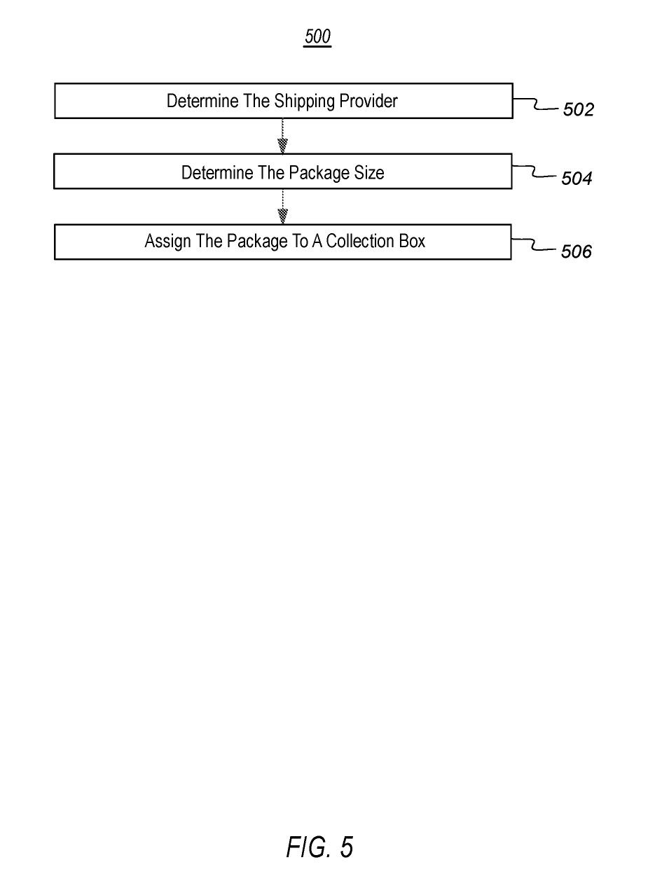

FIG. 5 is a flow chart illustrating an example of a hybrid intelligent intake method 500. The hybrid intelligent intake system 400 places all incoming packages in the correct collection box for pickup. For example, each shipping provider may need different sizes of collection boxes based on their business model. For example, if a shipping provider ships only certain articles, then collection boxes can be tailored to those articles.

FIG. 5 shows that hybrid intelligent intake method 500 can include determining 502 the shipping provider. That is, each package must be segregated based on the carrier that will actually collect the package; otherwise, the packages will be mixed and the packages will have to be sorted by hand, a time consuming practice. Typically, the shipping provider is selected by the user prior to intake. However, the system may allow a user to compare prices and ship times in order to select the shipping provider at the time of drop off.

FIG. 5 also shows that the hybrid intelligent intake method 500 can include determining 504 the package size. As used herein, size can refer to either the dimensions of the package, the weight of the package, or both. The majority of packages are small in dimension (particularly in width) but some are larger. In general, small packages can be placed with one another while larger packages need to be placed in their own locker based on their dimensions. This is because small packages can fit tightly within a space, whereas larger packages will leave large empty spaces if placed with one another.

FIG. 5 further shows that the hybrid intelligent intake method 500 can include assigning 506 the package to a collection box. The collection box for smaller packages will be a combined box for all smaller packages being shipped with that shipping provider. I.e., all smaller packages being shipped with USPS will be placed in a single collection box. Larger packages, in contrast, will be assigned 506 to the smallest available individual collection box that will accommodate the package. The collection box can be either a collection box that is always assigned to the particular shipping provider or can be a box that can be used by any shipping provider, the opened when that shipping provider is picking up packages.

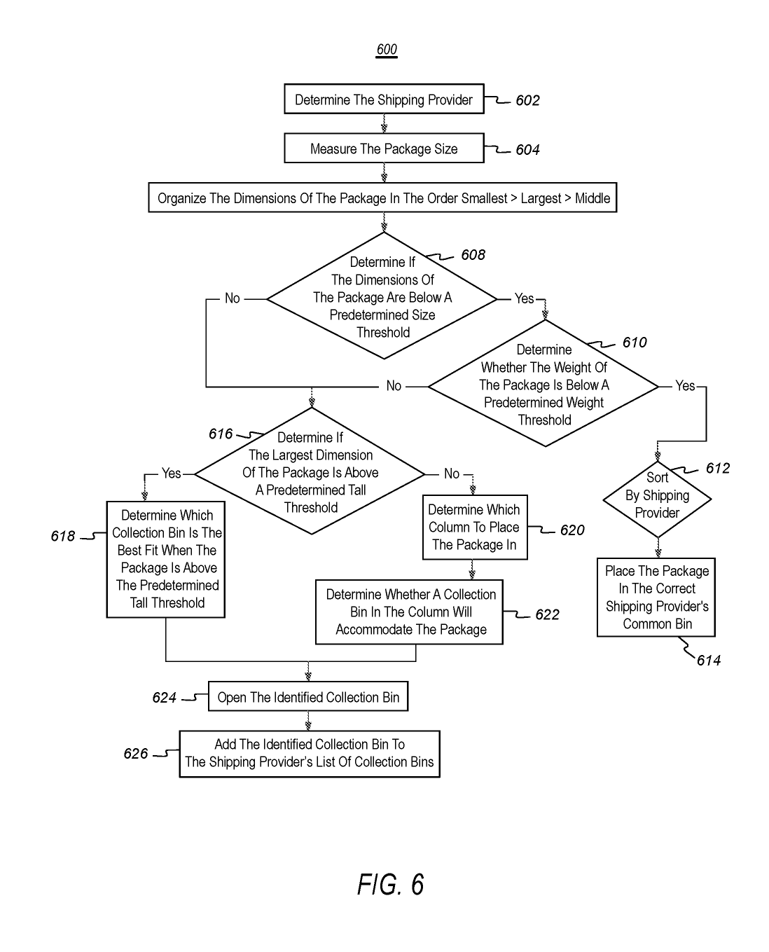

FIG. 6 is a flowchart illustrating an example of a method 600 for one particular hybrid intelligent intake system. The decision tree will vary depending on a number of factors. For example, at different locations, different shipping providers may be available. Likewise, some locations may have less space available, which means only smaller collection boxes will be available and may, therefore, only accept packages below a certain size. Thus, the method 600 provides an example of one possible decision tree for a hybrid intelligent intake system and is not necessarily restrictive regarding other possible decision trees.

FIG. 6 shows that the method 600 can include determining 602 the shipping provider. That is, each package must be segregated based on the carrier that will actually collect the package; otherwise, the packages will be mixed and the packages will have to be sorted by hand, a time consuming practice. Typically, the shipping provider is selected by the user prior to intake. However, the system may allow a user to compare prices and ship times in order to select the shipping provider at the time of drop off.

FIG. 6 also shows that the hybrid intelligent intake method 600 can include measuring 604 the package size. As used herein, size can refer to either the dimensions of the package, the weight of the package, or both. The majority of packages are small in dimension (particularly in width) but some are larger. In general, small packages can be placed with one another while larger packages need to be placed in their own locker based on their dimensions. This is because small packages can fit tightly within a space, whereas larger packages will leave large empty spaces if placed with one another. Measuring 604 can include fitting the package dimensions to the smallest possible cuboid. The package is then treated as if it were a cuboid with the best fit dimensions.

FIG. 6 shows that the method 600 can include organizing 606 the dimensions of the package in the order smallest>largest>middle. E.g., the dimensions of the package are arranged such that the smallest dimension in inches is the first data point, the largest dimension in inches is the second data point and the remaining data point is the middle dimension in inches. The order of the dimensions is somewhat arbitrary but should be consistent to ensure that following steps are performed correctly. If the dimensions are not in the above order, then they are placed in that order. One of skill in the art will appreciate that not all packages are cuboid; however, if the collection boxes are all cuboid (most, if not all, will be for simple convenience of construction) then the dimensions will have to be “best fit” to cuboid dimensions. I.e., the smallest cuboid which will accept the package will have to be calculated and then the package will be treated as if it is a cuboid of that size.

FIG. 6 also shows that the method 600 can include determining 608 if the dimensions of the package are below a predetermined size threshold. The predetermined size threshold is based on the size of the common bins. I.e., the predetermined size threshold is used to determine if the package is “small” or “large” for the purposes of the hybrid intelligent intake method 500 of FIG. 5. In the example of FIG. 6, the predetermined size threshold is 6″×18″×15″. Thus, any package below the size of 6″×18″×15″ is considered small and any package above the size of 6″×18″×15″ is considered large. Only one dimension need be above the predetermined size threshold for the package to be considered large. I.e., a package of size 2″×20″ by 12″ would be considered large in the example of FIG. 6, even though two of the three dimensions would be below the predetermined size threshold.

FIG. 6 further shows that the method 600 can include determining 610 whether the weight of the package is below a predetermined weight threshold when the size of the package is below the predetermined size threshold. The predetermined weight threshold is at least partially based whether the current package will damage other packages if placed in a common bin. In the example of FIG. 6, a weight under 4 pounds is considered “light” and a weight over 4 pounds is considered “heavy.”

FIG. 6 additionally shows that the method 600 can include sorting 612 by shipping provider when the weight of the package is below the predetermined weight threshold. That is, any package that is considered “small” and “light” is then sorted 612 according to the shipping provider. Small and light packages can be placed within one another because there is little to no risk of the packages damaging one another.

FIG. 6 moreover shows that the method 600 can include placing 614 the package in the correct shipping provider's common bin. Sorting 612 and placing 614 can be done automatically (i.e., the package is received and moved internally into the correct common bin), can be done by the user, or can be a mixture of both. For example, if the package is small and light, then the collection bin (or an opening, such as a slot, which allows depositing of the package) can be unlocked allowing the user to placed the package in the shipping provider's common bin.

FIG. 6 also shows that the method 600 can include determining 616 if the largest dimension of the package is above a predetermined tall threshold if the package is above the predetermined size threshold or if the package is above the predetermined weight threshold. I.e., if the package is large and heavy, it needs to be determined whether the package is considered tall. In the example of FIG. 6, any package longer than 40 inches is considered tall.

FIG. 6 further shows that the method 600 can include determining 618 which collection bin is the best fit when the package is above the predetermined tall threshold. Best fit is determined 618 by which locker is the smallest that will accept the package. In some cases, the collection bins will have a fixed depth. Therefore, the best fit will be determined by the smallest dimension if the middle dimension is smaller than the fixed depth and by the middle dimension if the middle dimension is smaller than the fixed depth.

FIG. 6 additionally shows that the method 600 can include determining 620 which column to place the package in when the largest dimension is below the predetermined tall threshold. Typically, each column will have a fixed depth which is less than the predetermined tall threshold, so it is known that the largest dimension is smaller than the depth. Therefore, the correct column is determined 620 by identifying the narrowest column with an available collection bin that fits both the middle and the smallest dimension. I.e., as long as the smallest dimension is smaller than the smallest of the width and the height of a collection bin AND the middle dimension is smaller than the largest of the width and the height. In general, the height will be smaller than the width (because a height of 12 inches in a column of 9 inches is better fit into a column with a width of 12 inches and a height of 9 inches—since uniformity in width allows for a maximum number of collection bins) which will simplify determining 620 which column to place the package in to finding the smallest width column which is larger than the middle dimension. For example, if the smallest column has a width of 9 inches, a depth of 40 inches, and heights varying between 4 and 9 inches, and the dimensions are 8″×20″×10″ (the package is large, because two dimensions are above the predetermined size threshold but the largest dimension is below the predetermined tall threshold) then the package won't fit because the middle dimension of ten inches will not fit the width of the column or the height of the column. However, if the next largest column has a width of 12 inches, a depth of 40 inches and heights varying from 4 to 12 inches, then the package will fit in the column because the middle dimension of ten inches is below the width of the column.

FIG. 6 moreover shows that the method 600 can include determining 622 whether a collection bin in the column will accommodate the package. Because the depth can accommodate the largest dimension and the width can accept the middle dimension (under the assumptions above), determining 622 whether a collection bin in the column will accommodate the package becomes determining whether there is an available collection bin with a height which is larger than the smallest dimension of the package. If no collection bin is available, then the method returns to the step 620 with the current column eliminated. I.e., in the example above (a width of 12 inches, a depth of 40 inches and heights varying from 4 to 12 inches, and the dimensions are 8″×20″×10″) where all bins with a height larger than 8 inches are full then the method 600 returns to the step 620 with the 9-inch column eliminated. The loop is exited once a collection bin is identified.

FIG. 6 also shows that the method 600 can include opening 624 the identified collection bin as a result of either step 618 or the step 622. The collection bin can have an electronic lock that is released allowing the user to open the collection bin and place the package within the collection bin. When the door is closed, the lock is reengaged and the collection bin is removed from the list of available collection bins. Thus, the package is secured and ready for pickup and no other packages can be placed in that particular collection bin.

FIG. 6 further shows that the method 600 can include adding 626 the identified collection bin to the shipping provider's list of collection bins. I.e., when collection bin is closed and locked then the collection bin is linked to the shipping provider so that when the shipping provider collects packages, the package will be released to the correct shipping provider.

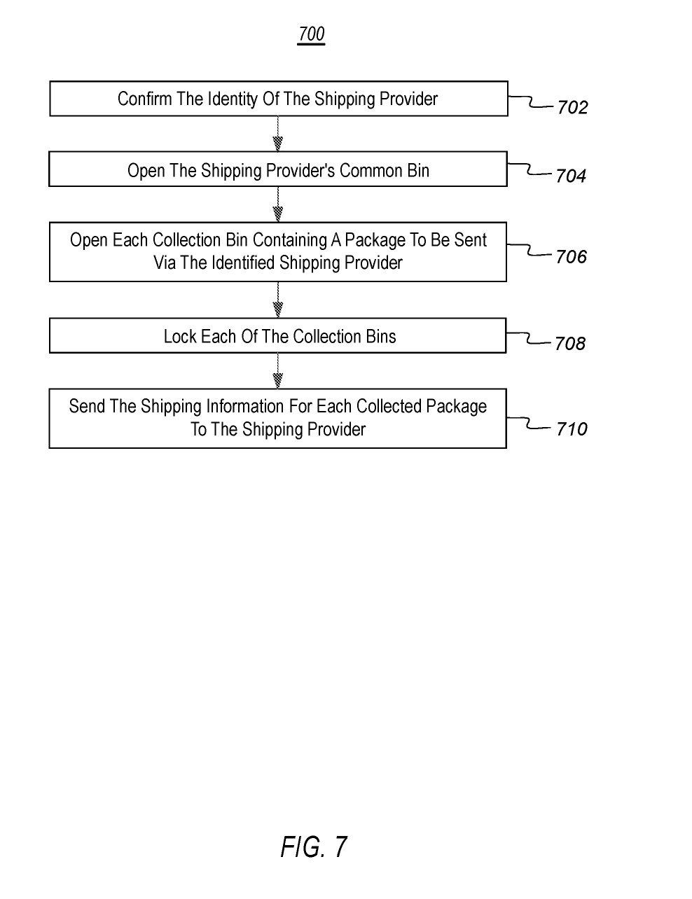

FIG. 7 is a flowchart illustrating a method 700 of providing packages at a drop box to a shipping provider. It is critical that each shipping provider receive all packages that are meant for that shipping provider and no packages that are intended for other shipping providers. Otherwise, the shipping provider needs to sort the packages manually, which eliminates any benefits to the shipping provider. Thus, the method 700 must be convenient for the shipping provider and require the least amount of sorting possible.

FIG. 7 shows that the method 700 can include confirming 702 the identity of the shipping provider. Because the shipping provider will have many different employees that can possible do the actual pickup, confirming 702 the identify of the shipping provider includes anything that allows the shipping provider's system to provide access to a designated employee. For example, a one-time code can be sent to the shipping provider, which then sends the code to the employee. Likewise, there is authorization software available which allows for three-way “handshakes” that can be used to confirm employee identities.

FIG. 7 also shows that the method 700 can include opening 704 the shipping provider's common bin. Because all “small” packages are sorted by shipping provider, everything in the shipping provider's common bin should be removed by the shipping provider's employee. This may include the presence of a container (such as a plastic bin) that can be easily removed.

FIG. 7 further shows that the method 700 can include opening 704 each collection bin containing a package to be sent via the identified shipping provider. That is, each collection bin where a package has been placed must be opened so the shipping provider can take possession of the packages therein.

FIG. 7 additionally shows that the method 700 can include locking 706 each of the collection bins. Locking may be accomplished as soon as the shipping provider has removed all packages or there may be indicators or alarms associated with each collection bin that provides a warning to the shipping provider regarding which collection bins still contain a package. For example, there may be a light indicator on the collection bins that have packages to be removed, with the light indicator being turned off and the collection bin being locked as soon as the shipping provider shuts the collection bin.

FIG. 7 moreover shows that the method 700 can include sending 708 the shipping information for each collected package to the shipping provider. The shipping information can be sent 708 electronically. That is, a message can be sent 708 to the shipping provider which includes the information for each package so that the shipping provider can provide updates to the user (if requested). Sending 708 the shipping information prevents each shipping provider from having to scan each package.

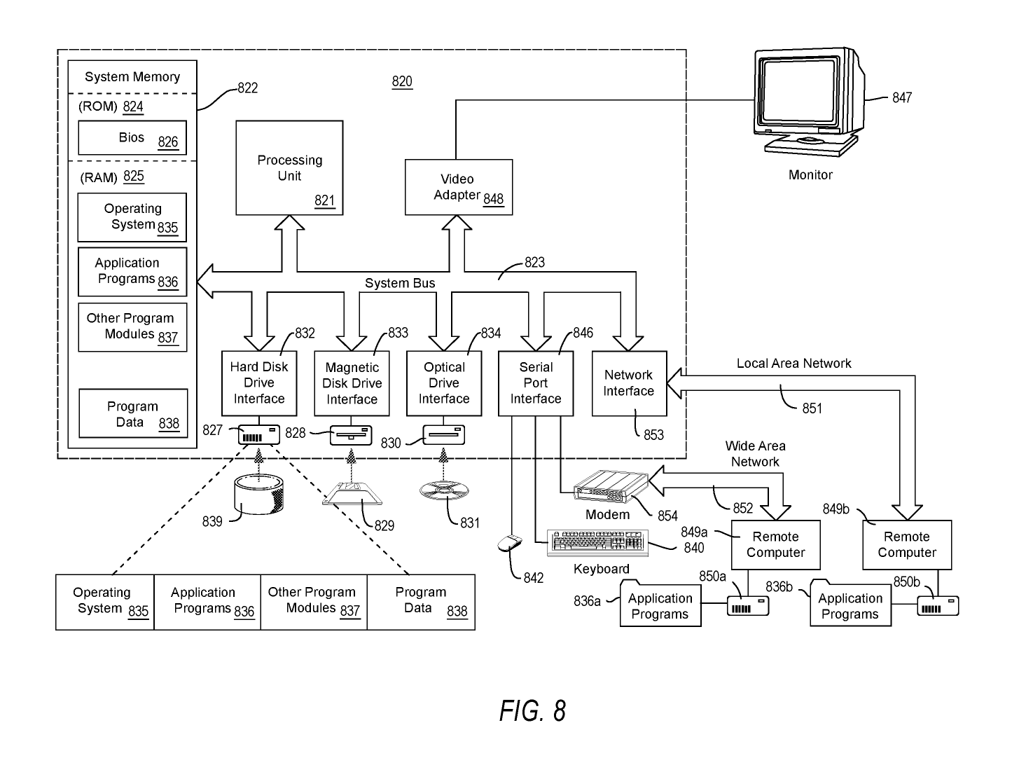

FIG. 8, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 8, an example system for implementing the invention includes a general purpose computing device in the form of a conventional computer 820, including a processing unit 821, a system memory 822, and a system bus 823 that couples various system components including the system memory 822 to the processing unit 821. It should be noted however, that as mobile phones become more sophisticated, mobile phones are beginning to incorporate many of the components illustrated for conventional computer 820. Accordingly, with relatively minor adjustments, mostly with respect to input/output devices, the description of conventional computer 820 applies equally to mobile phones. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824.

The computer 820 may also include a magnetic hard disk drive 827 for reading from and writing to a magnetic hard disk 839, a magnetic disk drive 828 for reading from or writing to a removable magnetic disk 829, and an optical disc drive 830 for reading from or writing to removable optical disc 831 such as a CD-ROM or other optical media. The magnetic hard disk drive 827, magnetic disk drive 828, and optical disc drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the exemplary environment described herein employs a magnetic hard disk 839, a removable magnetic disk 829 and a removable optical disc 831, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 839, magnetic disk 829, optical disc 831, ROM 824 or RAM 825, including an operating system 835, one or more application programs 836, other program modules 837, and program data 838. A user may enter commands and information into the computer 820 through keyboard 840, pointing device 842, or other input devices (not shown), such as a microphone, joy stick, game pad, satellite dish, scanner, motion detectors or the like. These and other input devices are often connected to the processing unit 821 through a serial port interface 846 coupled to system bus 823. Alternatively, the input devices may be connected by other interfaces, such as a parallel port, a game port or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, a peer device or other common network node, and typically include many or all of the elements described above relative to the computer 820, although only memory storage devices 850a and 850b and their associated application programs 836a and 836b have been illustrated in FIG. 8. The logical connections depicted in FIG. 8 include a local area network (LAN) 851 and a wide area network (WAN) 852 that are presented here by way of example and not limitation. Such networking environments are commonplace in office-wide or enterprise-wide computer networks, intranets and the Internet.

When used in a LAN networking environment, the computer 820 can be connected to the local network 851 through a network interface or adapter 853. When used in a WAN networking environment, the computer 820 may include a modem 854, a wireless link, or other means for establishing communications over the wide area network 852, such as the Internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are exemplary and other means of establishing communications over wide area network 852 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for shipping management, the system comprising:
a shipping database configured to receive shipping information from a user regarding a physical package;
an access point, the access point:
connected to the shipping database;
configured to receive the shipping information from the shipping database;
configured to measure at least one attribute of the physical package; and
configured to send the measured attribute to the shipping database to be added to the shipping information; and
a package drop, the package drop configured to:
receive the shipping information from the database;
accept the physical package from the user;
store the physical package until pickup by a shipping provider; and
based on the shipping provider assigning the physical package to a collection box.

2. The system of claim 1, wherein assigning the physical package to the collection box includes:
assigning the physical package to a common bin assigned to the shipping provider.

3. The system of claim 1, wherein assigning the physical package to the collection box includes:
assigning the physical package to a collection bin then assigning the collection bin to the shipping provider.

4. The system of claim 1, wherein assigning the physical package to the collection box includes:
assigning the physical package to a common bin assigned to the shipping provider when the physical package is below a predetermined size threshold.

5. The system of claim 1, wherein assigning the physical package to the collection box includes:
assigning the physical package to a common bin assigned to the shipping provider when the physical package is below:
a predetermined size threshold; and
a predetermined weight threshold.

6. The system of claim 1, wherein assigning the physical package to the collection box includes:
assigning the physical package to a collection bin then assigning the collection bin to the shipping provider when the physical package is above a predetermined size threshold.

7. The system of claim 1, wherein assigning the physical package to the collection box includes:
assigning the physical package to a collection bin then assigning the collection bin to the shipping provider when the physical package is above either:
a predetermined size threshold; or
a predetermined weight threshold.

8. A system for shipping management, the system comprising:
a shipping database configured to receive shipping information from a user regarding a physical package;
an access point, the access point:
connected to the shipping database;
configured to receive the shipping information from the shipping database;
configured to measure the dimensions and weight of the physical package;
configured to send the measured attributes to the shipping database to be added to the shipping information; and
determine if the dimensions of the physical package are below a predetermined size threshold;
determine if the weight of the physical package is below a predetermined weight threshold when the dimensions of the physical package are below the predetermined size threshold;
assign the physical package to a common bin assigned to the shipping provider when the physical package is below the predetermined size threshold and below the predetermined weight threshold; and
assign the physical package to a collection bin then assign the collection bin to the shipping provider when the physical package is above either:
the predetermined size threshold; or
the predetermined weight threshold.
a package drop, the package drop configured to:
receive the shipping information from the database;
accept the physical package from the user; and
store the physical package in either the shipping provider's common bin or the collection box.

9. The system of claim 8, further comprising:
wherein measuring the dimensions of the physical package includes fitting the physical package dimensions to the smallest possible cuboid.

10. The system of claim 8, further comprising:
wherein measuring the dimensions of the physical package includes organizing the dimensions of the physical package in the order smallest>largest>middle.

11. The system of claim 8, wherein the predetermined size threshold is approximately 6 inches×18 inches×15 inches.

12. The system of claim 8, wherein the predetermined weight threshold is approximately four pounds.

13. The system of claim 8, wherein assigning the physical package to a collection bin includes:
determining if the largest dimension of the physical package is above a predetermined tall threshold.

14. The system of claim 13, wherein assigning the physical package to a collection bin includes:
determining which collection bin is the best fit when the physical package is above the predetermined tall threshold.

15. The system of claim 14, wherein determining which collection bin is the best fit includes determined which locker is the smallest that will accept the physical package.

16. The system of claim 8, wherein assigning the physical package to a collection bin includes:
determining a column of collection bins to assign the physical package to when the physical package is below the predetermined tall threshold.

17. A system for shipping management, the system comprising:
a shipping database configured to receive shipping information from a user regarding a physical package;
an access point, the access point:
connected to the shipping database;
configured to receive the shipping information from the shipping database;
configured to measure the dimensions and weight of the physical package;
configured to send the measured attributes to the shipping database to be added to the shipping information; and
determine if the dimensions of the physical package are below a predetermined size threshold;
determine if the weight of the physical package is below a predetermined weight threshold when the dimensions of the physical package are below the predetermined size threshold;
assign the physical package to a common bin assigned to the shipping provider when the physical package is below the predetermined size threshold and below the predetermined weight threshold; and
assign the physical package to a collection bin then assign the collection bin to the shipping provider when the physical package is above either:
the predetermined size threshold; or
the predetermined weight threshold.
a package drop, the package drop configured to:
receive the shipping information from the database;
accept the physical package from the user; and
store the physical package in either the shipping provider's common bin or the collection box; and
open the shipping provider's common bin and all collection boxes assigned to the shipping provider to release the physical packages therein to the shipping provider.

18. The system of claim 17, further comprising:
confirming the identity of the shipping provider prior to opening the shipping provider's common bin and all collection boxes assigned to the shipping provider.

19. The system of claim 17, further comprising:
sending the shipping information from the shipping database to the shipping provider after the provider's common bin and all collection boxes assigned to the shipping provider.
